(19) United States
(12) Patent Application Publication
(10) Pub. No.: US 2022/0335298 A1
(43) Pub. Date: Oct. 20, 2022

(54) ROBUST LEARNING DEVICE, ROBUST LEARNING METHOD, PROGRAM, AND STORAGE DEVICE

(71) Applicant: NEC Corporation, Minato-ku, Tokyo (JP)

(72) Inventors: Takuma AMADA, Tokyo (JP); Kazuya KAKIZAKI, Tokyo (JP); Toshinori ARAKI, Tokyo (JP)

(73) Assignee: NEC Corporation, Minato-ku, Tokyo (JP)

(21) Appl. No.: 17/764,316

(22) PCT Filed: Oct. 1, 2019
(86) PCT No.: PCT/JP2019/038732

§ 371 Date: Mar. 28, 2022

(51) Int. Cl. G06N 3/08; G06N 3/04

(52) U.S. Cl. CPC G06N 3/08; G06N 3/0454

(57) ABSTRACT

A robust learning device is a learning device that, with a parameter of n neural networks, training data, and a correct label serving as inputs, outputs the updated parameter, including: a model selection unit that selects neural networks, which are less than n and equal to or more than two, among the n neural networks; a limited objective function calculation unit that calculates, in a calculation process of an objective function including a process in which a value of the objective function becomes smaller as an output of the neural networks to the training data is closer to the correct label and a degree of similarity between the neural networks is smaller, a limited objective function including only the process relating to the neural networks selected by the model selection unit; and an update unit that updates the parameter such that a value of the limited objective function is decreased.

### TECHNICAL FIELD

The present invention relates to a robust learning device, a robust learning method, a program, and a storage device that construct a plurality of machine learning models.

### BACKGROUND ART

Machine learning, especially deep learning, realizes highly accurate pattern recognition without the need for manual rule description and feature design due to the improvement in a computer performance and the advance of an algorithm. Autonomous driving is one of the applications attracting attention. In addition, highly accurate biometric authentication technology to which image human awareness and voice recognition are applied is also a typical application.

On the other hand, there is vulnerability in the trained model constructed by machine learning. A problem is known that the use of an adversarial sample, which is an artificial sample skillfully created to deceive the trained model, induces an unexpected malfunction during training. In one method of generating the adversarial sample, a region in which a target classifier is prone to error is specified by analyzing how a classifier, which is the artificial intelligence of a target to be attacked by the adversarial sample, responds to the input, and a sample can be artificially generated to guide the region. Such a sample can induce an incident, such as a malfunction or an uncontrollable error, in a system or an AI model that uses the classifier as decision logic.

For example, one example of the adversarial sample to the classifier that trains the task of recognizing traffic signs include a sample in which an existing sign is pasted with a sticker skillfully created to misclassify the sign as a specific traffic sign, a sample in which a specific part of a certain sign is removed, and a sample in which noise that cannot be recognized by a human is added. For generating the adversarial sample, a method (white box attack) in which noise is put on the sample such that an error between the output of the trained model and the correct answer is increased in a situation in which an attacker can access the parameters of the trained model, and a method in which the attacker does not access the parameters of the model, another learning model is constructed from a relationship between the input and the output, and a desired adversarial sample is generated by the white box attack to the model is well known.

As a countermeasure against the problems caused by the adversarial sample, a method of robustly constructing a learning model has been proposed (Non-Patent Document 1). Here, “robust” means a state in which, when the adversarial sample slightly different from a certain sample is input, misclassification to a class other than a correct class for a normal sample is unlikely to occur. Learning of the learning model while achieving a predetermined robustness is called robust learning. Among the robust learning methods of the adversarial sample, in the method disclosed in Non-Patent Document 1, a plurality of models are prepared and learning is executed such that a direction of a gradient vector with respect to the input is different between the models. It is the technology of preventing all models being similarly deceived as an effect of noise used to generate the adversarial sample tends to be different between the models.

In a process of generating a machine learning model, a function called a prediction loss function is used which is defined by an error between output of the model and the correct label of learning data, and is defined such that a prediction result of the network is closer to the learning data as the error is smaller. By differentiating the prediction loss function, the process of generating the model proceeds by updating the parameters such that the value of the prediction loss function is decreased. Learning is advanced by executing such an update process a plurality of times, and the model is generated by the output of the model becoming sufficiently close to the correct label of the learning data, or by executing an update process as much as scheduled.

In the method disclosed in Non-Patent Document 1, in addition to the prediction loss function, a function that is decreased when an update direction of the parameter of each model is different is used. Specifically, a function is used in which the degree of similarity between the gradient vectors indicating the direction of change of the input data in which the prediction loss function is increased is summed for all models. The function is called a gradient loss function. For the gradient loss function, for example, the calculation of the degree of similarity of cosine between two vectors is executed. The sum of the degrees of similarity of cosine between the gradient vectors is decreased as the direction of the gradient vector is different for each model.

In the method disclosed in Non-Patent Document 1, the process of generating the model is executed by differentiating the sum of the prediction loss function and the gradient loss function, and updating the parameters such that the sum is decreased. In a case in which the parameters are updated repeatedly under this conditions, the parameters are closer to the parameters that satisfy both conditions. The prediction loss function plays a role in improving the prediction accuracy, and the gradient loss function plays a role in updating the gradient vector of each model in different directions. The gradient vector of each model is updated in different directions to improve robustness to the adversarial sample.

In the method disclosed in Non-Patent Document 1, since the objective function of learning includes the prediction loss function and the gradient loss function, and the gradient loss function includes the gradient vectors of all the models which are learning targets, when the generated calculation graph is back-propagated, the differential coefficients of the network parameters of all models are obtained, so that a differential process is heavy. It should be noted that updating the parameters of the neural networks to reflect the prediction results of all the training data is regarded as one learning epoch, and for the generation of the trained model, learning is executed by only the determined number of epochs, or learning is executed until sufficient accuracy is achieved in inference.

### PRIOR ART DOCUMENTS

### Non-Patent Documents

Non-Patent Document 1: “Improving Adversarial Robustness of Ensembles with Diversity Training”, “online”, “search on Aug. 26, 2019”, the Internet <URL: https://arxiv.org/abs/1901.9981>

### SUMMARY OF THE INVENTION

### Problem to be Solved by the Invention

The method of generating a plurality of models having different features disclosed in Non-Patent Document 1 requires a large amount of calculation. For example, in the method disclosed in Non-Patent Document 1, as the objective function when the model learns, a prediction loss indicating the accuracy of the model prediction and a gradient loss which is decreased when the update directions of another model are different, are used. For the calculation of the gradient loss, the gradient vectors for the inputs of all models are calculated and the degree of similarity of each vector is calculated. In a case in which the number of models to be generated is defined as n and the parameters are updated for the model i (=1, 2, . . . , n), n vectors are generated for the gradient loss calculation. The degree of similarity between the gradient vector of the model i and the gradient vector of the other model is calculated, and the prediction loss is added to obtain the objective function. In this case, the objective function of the model i includes the gradient vector of the other model, and in a case in which the model parameters are updated by a gradient method, the model i is updated such that the discrimination accuracy is increased and it is different from the other model, and the model other than the model i is updated such that the degree of similarity with the model i is decreased. Since the parameters for n models are updated by updating the model i, when the number of models that learn in parallel is increased, the learning time is increased in the order of O(n²). As the number of models that learn in parallel is increased, the learning time is inefficient.

The present invention provides a robust learning device, a robust learning method, a program, and a storage device capable of solving the problems described above.

### Means for Solving the Problem

According to an example aspect of the present invention, a robust learning device that, with a parameter of n neural networks, training data, and a correct label serving as inputs, outputs the updated parameter, includes: a model selection unit that selects neural networks, which are less than n and equal to or more than two, among the n neural networks; a limited objective function calculation unit that calculates, in a calculation process of an objective function including a process in which a value of the objective function becomes smaller as an output of the neural networks to the training data is closer to the correct label and a degree of similarity between the neural networks is smaller, a limited objective function including only the process relating to the neural networks selected by the model selection unit; and an update unit that updates the parameter such that a value of the limited objective function is decreased.

According to an example aspect of the present invention, a robust learning method that, with a parameter of n neural networks, training data, and a correct label serving as inputs, outputs the updated parameter, includes: selecting neural networks, which are less than n and equal to or more than two, among the n neural networks; calculating, in a calculation process of an objective function including a process in which a value of the objective function becomes smaller as an output of the neural networks to the training data is closer to the correct label and a degree of similarity between the neural networks is smaller, a limited objective function including only the process relating to the selected neural networks; and updating the parameter such that a value of the limited objective function is decreased.

According to an example aspect of the present invention, a program causes a computer that, with a parameter of n neural networks, training data, and a correct label serving as inputs, outputs the updated parameter, to execute: a process of selecting neural networks, which are less than n and equal to or more than two, among the n neural networks; a process of calculating, in a calculation process of an objective function including a process in which a value of the objective function becomes smaller as an output of the neural networks to the training data is closer to the correct label and a degree of similarity between the neural networks is smaller, a limited objective function including only the process relating to the selected neural networks; and a process of updating the parameter such that a value of the limited objective function is decreased.

According to an example aspect of the present invention, a storage device stores a program, the program causing a computer that, with a parameter of n neural networks, training data, and a correct label serving as inputs, outputs the updated parameter, to execute:

a process of selecting neural networks, which are less than n and equal to or more than two, among the n neural networks;

a process of calculating, in a calculation process of an objective function including a process in which a value of the objective function becomes smaller as an output of the neural networks to the training data is closer to the correct label and a degree of similarity between the neural networks is smaller, a limited objective function including only the process relating to the selected neural networks; and

a process of updating the parameter such that a value of the limited objective function is decreased.

### Effect of Invention

With the robust learning device, the robust learning method, the program, and the storage device mentioned above, it is possible to efficiently construct a learning model with a small learning time, which can avoid an unexpected behavior even when the adversarial sample is input, even when the number of models that learn dependently in parallel is increased in a case in which the learning model includes a plurality of models that learn dependently in parallel.

### BRIEF DESCRIPTION OF THE DRAWINGS

FIG. 1 is a block diagram showing an example of a robust learning device according to a first example embodiment of the present invention.

FIG. 2 is a block diagram showing an example of a limited objective function calculation device according to the first example embodiment of the present invention.

FIG. 3 is a flowchart showing an operation example of the robust learning device according to the first example embodiment of the present invention.

FIG. 4 is a block diagram showing an example of a limited objective function calculation device according to a second example embodiment of the present invention.

FIG. 5 is a block diagram showing an example of a robust learning device according to a third example embodiment of the present invention.

FIG. 6 is a diagram showing a minimum configuration of the robust learning device according to one example embodiment of the present invention.

FIG. 7 is a diagram showing an example of a hardware configuration of the robust learning device according to one example embodiment of the present invention.

### EXAMPLE EMBODIMENT

In the following, each example embodiment of the present invention will be described in detail with reference to the drawings. The following example embodiments do not limit the present invention according to the claims. In addition, all combinations of features described in the example embodiments are not always essential to means for solving the invention. In the drawings used in the following description, in some cases, a description of the configuration of parts not relating to the present invention is omitted and not shown.

### First Example Embodiment

(Description of Configuration)

FIG. 1 is a block diagram showing an example of a robust learning device according to a first example embodiment of the present invention.

As shown in FIG. 1, a robust learning device 10 includes a model selection unit 11, a limited objective function calculation device 100, and an update unit 12.

With respect to n, which is a natural number, the robust learning device 10 receives, as inputs, n neural networks f_1, f_2, . . . , and f_n, which learn dependent on each other, n parameters θ_1, θ_2, . . . , and θ_n, a plurality of training data X, correct labels Y corresponding to the training data X, and hyperparameters C and outputs updated parameters θ′_1, . . . , and θ′_n of the neural networks. It should be noted that the parameter θ_1 is a parameter of the neural network f_1, and the same applies to the parameter θ_2 and the like.

The neural networks f_1 to f_n constitute one learning model constructed for a certain purpose. As described below, each of the neural networks f_1 to f_n learns to output values close to the correct labels Y when the same training data X are input, while each of the neural networks f_1 to f_n learns such that the degree of similarity between the neural networks f_1 to f_n is decreased. By providing such neural networks f_1 to f_n in parallel in one learning model, it is possible to reduce the possibility that all neural networks are deceived even when adversarial parameters are input, and the learning model as a whole is safe. For example, the learning model has a function of controlling the neural networks f_1 to f_n, and by this function, the difference in the outputs of the neural networks f_1 to f_n is confirmed, and for example, a neural network that outputs a value that is significantly different from the others is considered to have a possibility of being deceived, and the output thereof is ignored, or for a neural network that is considered not to be deceived, for example, the average value of the output thereof is calculated, and the average value is adopted as final output of the learning model. The present invention relates to the technology of training the neural networks f_1 to f_n included in the learning model with a small learning time and a small amount of calculation.

The model selection unit 11 selects a plurality of neural networks among the neural networks f_1 to f_n. The model selection unit 11 outputs an index t_j of the selected model (j is an index of the neural network selected by the model selection unit 11 from 1 to n). It should be noted that, in the following, in some cases, each of the neural networks f_1 to f_n is described as a model.

The limited objective function calculation device 100 calculates an objective function relating to only a process relating to the neural network selected by the model selection unit 11 from the training data X, the neural networks f_1 to f_n, the parameters θ_1 to θ_n of the neural networks, and the correct labels Y, and outputs the calculated objective function.

The update unit 12 updates the parameter θ_i and the like of the neural network f_i and the like (i is any natural number from 1 to n) from the hyperparameters C and the objective function calculated by the limited objective function calculation device 100 such that the difference between the output of the neural network and the correct label Y is decreased at a ratio of C and the degree of similarity of gradient vector between the models is decreased.

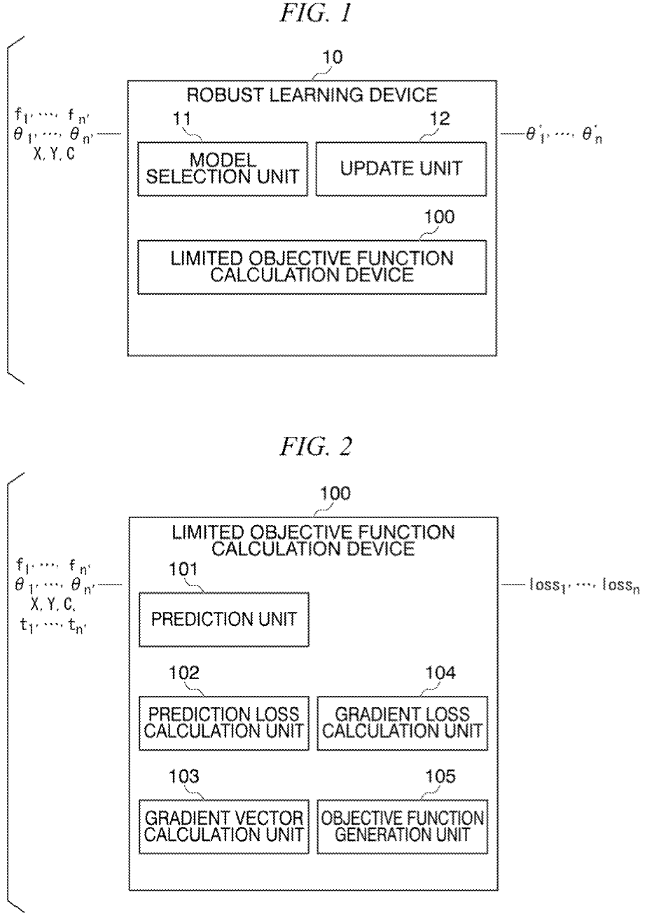

FIG. 2 is a block diagram showing an example of the limited objective function calculation device according to the first example embodiment of the present invention.

The limited objective function calculation device 100 includes a prediction unit 101, a prediction loss calculation unit 102, a gradient vector calculation unit 103, a gradient loss calculation unit 104, and an objective function generation unit 105.

The limited objective function calculation device 100 receives, as inputs, the neural networks f_1 to f_n, the parameters θ_1 to θ_n of the neural networks, the training data X, the correct labels Y, the hyperparameter C, and the index t_j of the neural network selected by the model selection unit 11.

The prediction unit 101 makes the prediction using the training data X and a plurality of neural networks f_1 to f_n. The prediction unit 101 inputs the training data X to the neural networks f_1 to f_n, and outputs the values output by the neural networks f_1 to f_n. In the present example embodiment, f_1 to f_n, θ_1 to θ_n, X, and Y input here may be optional.

The prediction loss calculation unit 102 calculates a prediction loss function based on an error between the output of each of the neural networks f_1 to f_n and the correct labels Y such that the training data X and the correct labels Y correspond to each other. For example, cross entropy can be used for a prediction loss function 1_i( ) of f_i.

The gradient vector calculation unit 103 calculates a gradient vector ∇_i of the error with respect to X as follows from the training data X and errors 1_1 to 1_n which are the outputs of the prediction loss calculation unit 102.

$$\begin{matrix}[ Math . 1 ] & \\ ∇ \_i = \frac{\partial l\_i}{\partial X} & ( 1 )\end{matrix}$$

As shown in the expression (1), the gradient vector indicates a change in the prediction loss function with respect to the perturbation of the training data X.

The gradient loss calculation unit 104 uses the gradient ∇_1 vectors to ∇_n as inputs, calculates the degree of similarity between ∇_i corresponding to the gradient vector of each f_i and n−1 other gradient vectors, and outputs the sum thereof as the gradient loss function. The calculation of the degree of similarity can be evaluated, for example, by calculating the degree of similarity of cosine between the two gradient vectors.

The objective function generation unit 105 adjusts a ratio of the prediction loss function 1_i( ) and the gradient loss function received from the prediction loss calculation unit 102 and the gradient loss calculation unit 104 according to the hyperparameter C, and outputs a value relating to the neural network selected by the model selection unit 11 as the objective function. Here, in a case where the prediction loss function 1_i( ), which indicates the difference between the output of the neural network f_i and the correct label Y, and a gradient loss function D( ), which indicates the sum of the degrees of similarity between the neural networks, are used, an objective function loss_i can be represented by loss_i=1_i( )+C×D( ).

(Description of Operation)

Next, an operation of the robust learning device 10 will be described.

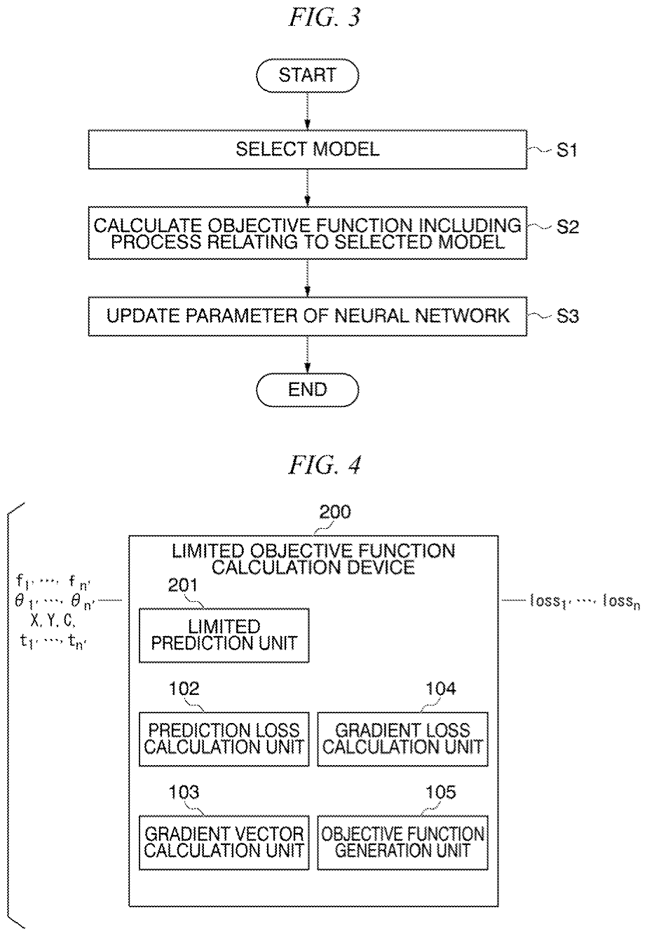

FIG. 3 is a flowchart showing an operation example of the robust learning device according to the first example embodiment of the present invention.

First, the n neural networks f_1 to f_n, the parameters θ_1 to θ_n, the training data X, the correct labels Y, and the hyperparameter C are input to the robust learning device 10.

Then, the model selection unit 11 selects a plurality of neural networks to be updated (S1). The number of neural networks to be selected is optional. The model selection unit 11 outputs the index t_j of the selected neural network to the limited objective function calculation device 100.

Next, the limited objective function calculation device 100 calculates the objective function including the process relating to the selected neural network (S2).

For example, in a case in which the model selection unit 11 selects the neural networks f_1 to f_3 among the neural networks f_1 to f_n (in a case in which t_j is t_1 to t_3), the limited objective function calculation device 100 executes, for example, the following process to calculate loss_1 to loss_n.

The prediction unit 101 inputs the training data X to the neural networks f_1 to f_n, and outputs the predictions by the n neural networks.

The prediction loss calculation unit 102 calculates, for example, prediction loss functions 1_1( ) to 1_n( ) with respect to the neural networks f_1 to f_n.

The gradient vector calculation unit 103 calculates gradient vectors ∇_1 to ∇_n.

The gradient loss calculation unit 104 calculates the degrees of similarity for all combinations of the two gradient vectors corresponding to the selected neural networks among the gradient vectors ∇_1 to ∇_n, and calculates the sum thereof. For example, in the case of the present example, for the neural network f_i, the sum of the degree of similarity between ∇_i and ∇_1, the degree of similarity between ∇_i and ∇_2, and the degree of similarity between ∇_i and ∇_3 is calculated.

The objective function generation unit 105 outputs, for the neural networks f_1 to f_n, the objective functions loss_1 to loss_n.

Next, the update unit 12 updates the parameter from the differential coefficient in the parameter of the neural network of the objective function output by the limited objective function calculation device 100 (S3). For example, the update unit 12 adjusts the parameter θ_1 of the neural network f_1 such that the value of the prediction loss function (error between the prediction value and the correct label Y) in the objective function loss_1 is decreased and the value of the gradient loss function (degree of similarity between the neural networks) is decreased. The same applies to the parameters θ_2 to θ_n.

In the construction of the learning model composed of N models, in a case in which the objective function for learning includes the prediction loss function that plays a role in improving the prediction accuracy and the gradient loss function for improving the robustness to the adversarial parameter, and the gradient loss function is calculated by the degree of similarity of the gradient vector between the two models, in a general method, for a certain model i, the model i is updated such that the discrimination accuracy is increased and its gradient vector is different from the other model, and n−1 model other than the model i is updated such that its gradient vector is different from the model i. Therefore, the learning time is required in the order of O(n²). On the other hand, according to the present example embodiment, when the model selection unit 11 selects p models from the number of models n, the gradient vector is updated for only p neural networks, so that the execution time can be reduced in the order of O(n×p).

As a result, according to the present example embodiment, a model group having the feature that it is possible to reduce the possibility of discrimination error of all models for the adversarial sample and increase the discrimination accuracy of each model for the normal sample can be constructed at high speed with a smaller amount of calculation than, for example, the method disclosed in Non-Patent Document 1. In addition, by using the learning model constructed by the present example embodiment, it is possible to safely use the AI system/learning model in which the adversarial sample may be input.

### Second Example Embodiment

(Description of Configuration)

In the following, the robust learning device according to a second example embodiment of the present invention will be described with reference to FIG. 4.

FIG. 4 is a block diagram showing an example of the limited objective function calculation device according to a second example embodiment of the present invention.

The robust learning device 10 according to the second example embodiment includes a limited objective function calculation device 200 instead of the limited objective function calculation device 100.

The limited objective function calculation device 200 includes a limited prediction unit 201 and does not include the prediction unit 101. Other configurations are the same as the configurations in the first example embodiment. The same components as the components in the first example embodiment are designated by the same reference symbols as the reference symbols in FIGS. 1 and 2, and a detailed description thereof will be omitted.

The limited prediction unit 201 makes the prediction for only the neural network f_j selected by the model selection unit 11, and outputs the prediction regarding the training data X only from the neural network selected by the model selection unit 11.

(Description of Operation)

A process of the second example embodiment will be described with reference to FIG. 3 used for the description of the first example embodiment.

First, the same values as the values in the first example embodiment are input to the robust learning device 10.

Then, the model selection unit 11 selects a plurality of neural networks to be updated (S1). The model selection unit 11 outputs the index of the selected neural networks to the limited objective function calculation device 200.

Next, the limited objective function calculation device 100 calculates the objective function including the process relating to the selected neural networks (S2).

For example, in a case in which the model selection unit 11 selects the neural networks f_1 to f_3 among the neural networks f_1 to f_n, the limited objective function calculation device 200 executes the following process.

The limited prediction unit 201 inputs the training data X to the neural networks f_1 to f_3 and outputs the predictions by the three neural networks.

The prediction loss calculation unit 102 calculates the prediction loss functions 1_1( ) to 1_3( ), for example.

The gradient vector calculation unit 103 calculates the gradient vectors ∇_1 to ∇_3.

The gradient loss calculation unit 104 calculates the degree of similarity between the gradient vectors ∇_1 and ∇_2, ∇_1 and ∇_3, and ∇_2 and ∇_3, and calculates the sum thereof. The objective function generation unit 105 outputs the objective functions loss_1 to loss_3.

Next, the update unit 12 updates the parameters of the neural networks (S3). For example, the update unit 12 adjusts the parameters θ_1 to θ_3 of the neural networks f_1 to f_3 such that the value of the prediction loss function is decreased and the value of the gradient loss function is decreased.

According to the present example embodiment, when the model selection unit 11 selects p models from the number of models n, the parameters for p models are updated with respect to the gradient loss function by updating a certain model i, and the parameters are calculated for the prediction loss function for p neural networks, so that the execution time can be reduced in the order of O(p×p).

### Third Example Embodiment

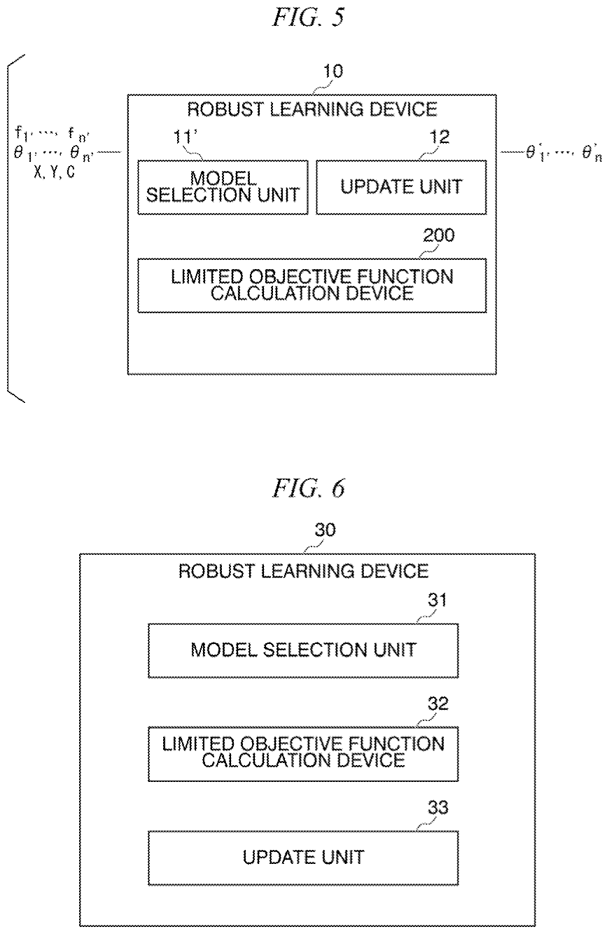

In the following, the robust learning device according to a third example embodiment of the present invention will be described with reference to FIG. 5.

FIG. 5 is a block diagram showing an example of the robust learning device according to a third example embodiment of the present invention.

In a case of being compared with the configuration of the first example embodiment, the robust learning device 10 according to the third example embodiment includes a model selection unit 11′ instead of the model selection unit 11, and a limited objective function calculation device 200 instead of the limited objective function calculation device 100.

The model selection unit 11′ selects a different number of neural networks for the limited prediction unit 201 and the gradient loss calculation unit 104. Other configurations are the same as the configurations in the second example embodiment. The same components as the components in the first example embodiment and the second example embodiment are designated by the same reference symbols as the reference symbols in FIGS. 1 and 2, and a detailed description thereof will be omitted.

The third example embodiment is an example embodiment in which the number of neural networks selected for output to the limited prediction unit 201 in the second example embodiment is p, and the number of neural networks selected for output to the gradient loss calculation unit 104 is k. For example, the model selection unit 11′ selects the neural networks f_1 to f_5 and outputs them to the limited prediction unit 201, and selects the neural networks f_1 to f_3 and outputs them to the gradient loss calculation unit 104. It should be noted that since the prediction loss function is required to calculate the gradient vector, the neural network selected for output to the gradient loss calculation unit 104 is a part of the neural network selected for output to the limited prediction unit 201. In the case of this example, the limited objective function calculation device 200 executes the following process in S2 of FIG. 3.

The limited prediction unit 201 inputs the training data X to the neural networks f_1 to f_5 and outputs the predictions by the five neural networks.

The prediction loss calculation unit 102 calculates the prediction loss functions 1_1( ) to 1_5( ).

The gradient vector calculation unit 103 calculates gradient vectors ∇_1 to ∇_5.

The gradient loss calculation unit 104 calculates the degree of similarity between the gradient vectors ∇_j (j=1 to 5) and ∇_1 to ∇_3, and calculates the sum thereof. For example, in a case in which j=1, the gradient loss calculation unit 104 calculates the sum of the degree of similarity between ∇_1 and ∇_2 and the degree of similarity between ∇_1 and ∇_3. For example, in a case in which j=5, the gradient loss calculation unit 104 calculates the sum of the degree of similarity between ∇_5 and ∇_2, the degree of similarity between ∇_5 and ∇_2, and the degree of similarity between ∇_5 and ∇_3.

The objective function generation unit 105 outputs the objective functions loss_1 to loss_5.

In addition, in a case in which the number of neural networks selected for the limited prediction unit 201 is p, and the number of neural networks selected for the gradient loss calculation unit 104 is k, the model selection unit 11′ may set the number of neural networks selected for the gradient loss calculation unit 104 as k=n/p. In this case, the order of the execution time is O(n).

According to the present example embodiment, the time for updating the parameters can be further shortened.

FIG. 6 is a diagram showing a minimum configuration of the robust learning device according to one example embodiment of the present invention.

The learning device 30 includes at least a model selection unit 31, a limited objective function calculation unit 32, and an update unit 33.

The learning device 30 inputs the parameters of a plurality of neural networks, the training data, and the correct labels. The model selection unit 31 selects two or more neural networks among a plurality of neural networks. The limited objective function calculation unit 32 calculates the limited objective function including only the process relating to the neural networks selected by the model selection unit 31 in a calculation process of the objective function used for parameter learning. In a case in which the output of the neural network for the training data is close to the correct label and the degree of similarity of the gradient vectors between the neural networks is decreased, the value of the limited objective function is decreased. The update unit 33 updates the parameters such that the value of the limited objective function is decreased.

In Non-Patent Document 1, what is dominant in execution time is that the parameters for n models are updated n times. On the other hand, according to the present example embodiment, by updating the parameter for only a part of models, it is possible to maintain the property that the models that learn have different features and to save the amount of calculation in learning.

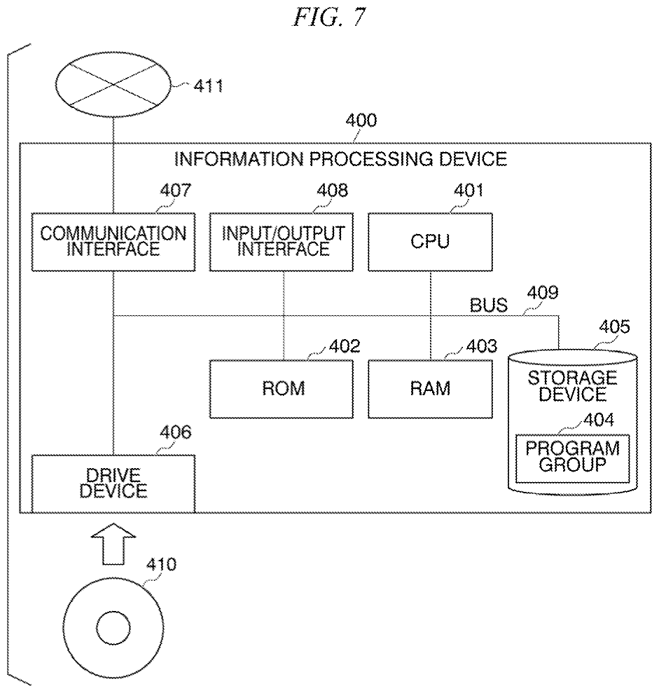

FIG. 7 is a diagram showing an example of a hardware configuration of the robust learning device according to one example embodiment of the present invention.

In the example embodiments described above, each component of the robust learning device 10 indicates a block of functional units. A part or all of the components of the robust learning device 10 can be realized by any combination of an information processing device 400 and the program as shown in FIG. 7, for example. As an example, the information processing device 400 can have the following configuration. That is, the information processing device 400 includes a central processing unit (CPU) 401, a read only memory (ROM) 402, a random access memory (RAM) 403, a program group 404 loaded into the RAM 403, a storage device 405 that stores the program group 404, a drive device 406 that reads and writes an external recording medium 410 of the information processing device 400, a communication interface 407 that is connected to an external network 411 of the information processing device 400, an input/output interface 408 that inputs and outputs the data, and a path 409 that connects the components.

Each component of the robust learning device 10 in the example embodiment described above can be realized by the CPU 401 acquiring the program group 404 that realizes these functions, deploying the program group 404 in the RAM 403, and executing the program group 404. The program group 404 that realizes the functions of the components of the robust learning device 10 is stored in, for example, the storage device 405 or the ROM 402 in advance, and the CPU 401 loads the program group 404 into the RAM 403 and executes the program as needed. It should be noted that the program group 404 may be supplied to the CPU 401 via the network 411, or may be stored in the recording medium 410 in advance, and the drive device 406 may read out the program and supply the program to the CPU 401. In addition, the program may be a program for realizing a part of the functions described above. Further, the program may be a so-called difference file (difference program) which realizes the functions described above in combination with another program already stored in the storage device 405 or the ROM 402.

It should be noted that FIG. 7 shows an example of the configuration of the information processing device 400, and the configuration of the information processing device 400 is not described as an exemplary example in the case described above. For example, the information processing device 400 may be configured from a part of the configuration, such as not including the drive device 406.

In addition, it is possible to replace the components in the example embodiments described above with well-known components without departing from the gist of the present invention. The technical scope of the present invention is not limited to the example embodiments described above, and it is possible to add various modifications without departing from the gist of the present invention.

### INDUSTRIAL APPLICABILITY

With the learning device, the learning method, the program, and the storage device, it is possible to efficiently construct a learning model with a small learning time, which can avoid an unexpected behavior even when the adversarial sample is input, even when the number of models that learn dependently in parallel is increased in a case in which the learning model includes a plurality of models that learn dependently in parallel.

### DESCRIPTION OF REFERENCE SYMBOLS

10: Robust learning device
11: Model selection unit
12: Update unit
100, 200, 300: Limited objective function calculation device
101: Prediction unit
102: Prediction loss calculation unit
103: Gradient vector calculation unit
104: Gradient loss calculation unit
105: Objective function generation unit
201: Limited prediction unit
301: Limited gradient loss calculation unit
400: Information processing device
401: Central processing unit (CPU)
402: Read only memory (ROM)
403: Random access memory (RAM)
404: Program group
405: Storage device
406: Drive device
407: Communication interface
408: Input/output interface
409: Path
410: External recording medium
411: Network

What is claimed is:

1. A robust learning device that, with a parameter of n neural networks, training data, and a correct label serving as inputs, outputs the updated parameter, the device comprising:
at least one memory configured to store instructions; and
at least one processor configured to execute the instructions to:
select neural networks, number of which is less than n and equal to or more than two, among the n neural networks;
calculate, in a calculation process of an objective function including a process in which a value of the objective function becomes smaller as an output of the neural networks to the training data is closer to the correct label and a degree of similarity between the neural networks is smaller, a limited objective function including only the process relating to the selected neural networks; and
update the parameter such that a value of the limited objective function is decreased.

2. The learning device according to claim 1, wherein the at least one processor is configured to execute the instructions to calculate only a degree of similarity between each of the n neural networks and the selected neural networks, and calculate the limited objective function including a process in which the value of the limited objective function becomes smaller as an output of the n neural networks is closer to the correct label and the calculated degree of similarity is smaller.

3. The robust learning device according to claim 1, wherein the at least one processor is configured to execute the instructions to calculate, for only the selected neural networks among the n neural networks, the limited objective function including a process in which the value of the limited objective function becomes smaller as an output of the selected neural networks is closer to the correct label and a degree of similarity between at least some of the selected neural networks is smaller.

4. A robust learning method that, with a parameter of n neural networks, training data, and a correct label serving as inputs, outputs the updated parameter, the method comprising:
selecting neural networks, number of which is less than n and equal to or more than two, among the n neural networks;
calculating, in a calculation process of an objective function including a process in which a value of the objective function becomes smaller as an output of the neural networks to the training data is closer to the correct label and a degree of similarity between the neural networks is smaller, a limited objective function including only the process relating to the selected neural networks; and
updating the parameter such that a value of the limited objective function is decreased.

5. A non-transitory recording medium that stores a program causing a computer that, with a parameter of n neural networks, training data, and a correct label serving as inputs, outputs the updated parameter, to execute:
selecting neural networks, which are less than n and equal to or more than two, among the n neural networks;
calculating, in a calculation process of an objective function including a process in which a value of the objective function becomes smaller as an output of the neural networks to the training data is closer to the correct label and a degree of similarity between the neural networks is smaller, a limited objective function including only the process relating to the selected neural networks; and
updating the parameter such that a value of the limited objective function is decreased.

6. (canceled)
